(19) United States
(12) Patent Application Publication
(10) Pub. No.: US 2003/0016396 A1
(43) Pub. Date: Jan. 23, 2003

(54) Communication terminal unit

(75) Inventor: Mitsuhiro Kinoshita, Mishima-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/196,555

(22) Filed: Jul. 17, 2002

(30) Foreign Application Priority Data
Jul. 18, 2001 (JP) 2001-218563

(51) Int. Cl. H04N 1/00

(52) U.S. Cl. 358/402

(57) ABSTRACT

A communication terminal unit including a display controller which gives a display identifying a facsimile mode and display the input facsimile number in a display when a facsimile number is input from an input section in the case where the facsimile mode is selected in a mode setting section, and give a display identifying an e-mail mode and display the input e-mail address when an e-mail address is input from the input section in the case where the mail mode is selected in the mode setting section.

### CROSS-REFERENCE TO RELATED APPLICATIONS

This application is based upon and claims the benefit of priority from the prior Japanese Patent Application No. 2001-218563, filed Jul. 18, 2001, the entire contents of which are incorporated herein by reference.

### BACKGROUND OF THE INVENTION

1. Field of the Invention

The present invention relates to a communication terminal unit having a facsimile mode of sending data to a remote terminal over a telephone line and a mail mode of sending pictorial data, as a file attached to an e-mail, to the remote terminal through a Internet.

2. Description of the Related Art

An ordinary facsimile sends data by specifying a destination facsimile number. In other words, a destination facsimile number is directly input from a ten-key numerical pad provided in an operation panel of a facsimile, and a telephone line is called. Or, a facsimile number already registered in memory as an abbreviated dial number is called up by depressing a corresponding one-touch dialing key, and a telephone line is called.

In recent years, a communication terminal unit which has a so-called Internet facsimile function in addition to an ordinary facsimile function has been developed. With this terminal unit, pictorial data can be transmitted as a file attached to a e-mail by specifying the e-mail address of a destination terminal through local area network (hereinafter referred to as LAN) or internet.

In such a communication terminal unit, a large display is usually not provided in the operation panel to reduce the production costs, and a small liquid crystal display (LCD) capable of displaying only a few lines is provided.

However, with such a small LCD, the entered facsimile number or e-mail address is displayed, but guide messages to identify the mode, facsimile or mail are not displayed because the displayable amount of data is limited.

In communication terminals with such a small LCD, it may be necessary to make setting of display resolution and thickness before input the facsimile number or e-mail address. And, if this setting takes a time, the input of the facsimile number or e-mail address will be delayed.

This delay may cause the operator to misunderstand the mail mode for the facsimile mode and input the facsimile number, and vice versa. Such mis-entry will not be found until an error message is displayed after the operator finishes all operations for transmission. This has been a problem in prior art communication terminal units.

### BRIEF SUMMARY OF THE INVENTION

An object of the present invention is provide a communication terminal unit which identifies the operation mode, facsimile or e-mail, immediately when a facsimile number or e-mail address is input.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a block diagram showing an embodiment of the present invention;

FIG. 2 is a view showing a structure of an operation panel in the same embodiment of the invention;

FIG. 3 is a diagram showing contents of a registration memory in the same embodiment of the invention;

FIG. 4 is a flow chart showing display controls in a facsimile mode and in a mail mode in the same embodiment of the invention;

FIG. 5 is a flow chart showing a searching process in the same embodiment of the invention; and

FIGS. 6A to 6G show display examples of a liquid crystal display in the same embodiment of the invention.

### DETAILED DESCRIPTION OF THE INVENTION

Hereinafter, an embodiment of the present invention will be explained with reference to the accompanying drawings.

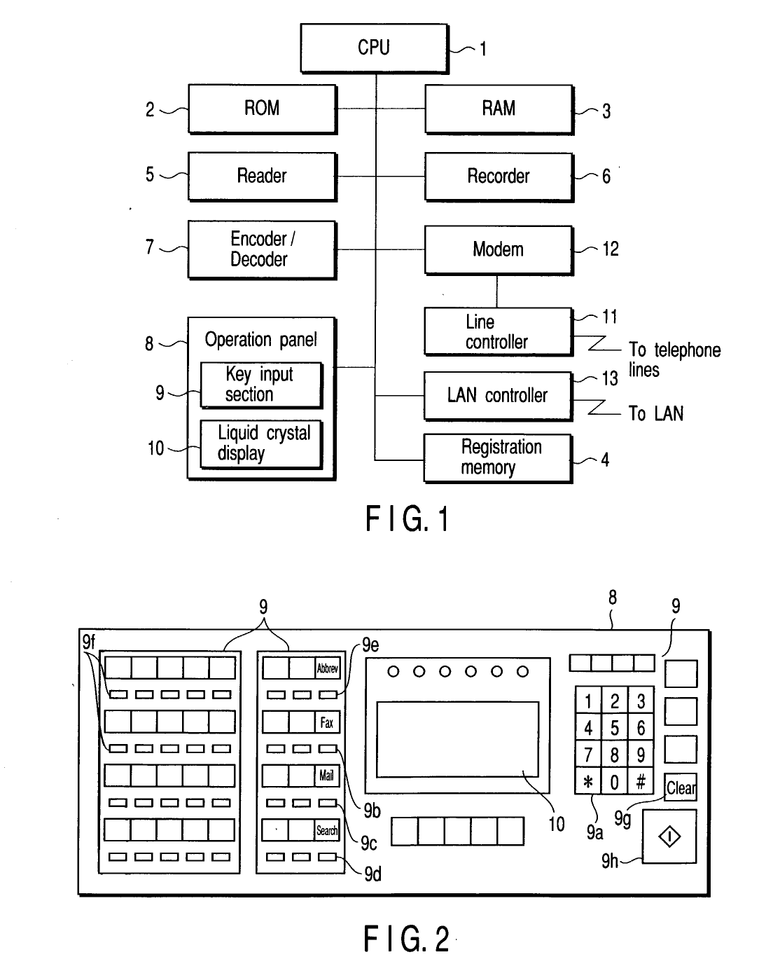

FIG. 1 is a block diagram showing an embodiment of the present invention, in which denoted at 1 is a central processing unit (CPU) constituting a control unit, denoted at 2 is a read only memory (ROM) storing program data used by CPU 1 to control each section, denoted at 3 is a random access memory (RAM) comprising a memory of temporarily storing data when CPU 1 handles data and a memory for temporarily storing data to be sent or received, and denoted at 4 is a registration memory for storing facsimile numbers or e-mail addresses of remote terminals together with station names by assigning them to respective abbreviated dial numbers or one-touch dialing keys.

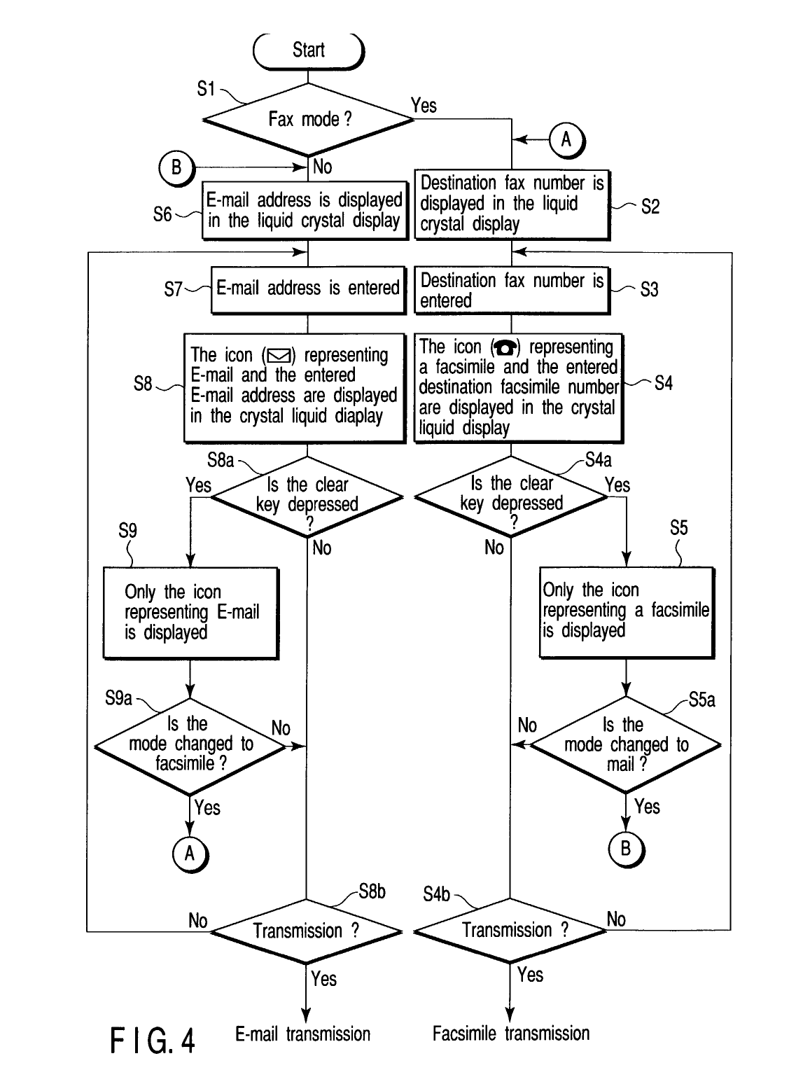

In this registration memory 4, as shown in FIG. 3, a facsimile number (or e-mail address) and station name are registered for each abbreviated dial number. For example, a facsimile number 045-712-1111 and station name YAMADA are assigned to an abbreviated dial number 1, and an e-mail address abc@ttec.co.jp and station name MISHIMA are assigned to an abbreviated dial number 2. Namely, only one of the facsimile number and e-mail address can be set as an abbreviated dial number. In FIG. 3, facsimile numbers (or e-mail addresses) and station names can also be assigned to one-touch dialing keys.

Also, denoted at 5 is a reader which reads a document and outputs bit map pictorial data, denoted at 6 is a recorder for recording received pictorial data on a recording paper, denoted at 7 is an encoder/decoder which encodes pictorial data to be sent and decodes received pictorial data, denoted at 8 is an operation panel which comprises a key input section 9 including various keys and a liquid crystal display 10 to give a display of up to 4 lines, for example.

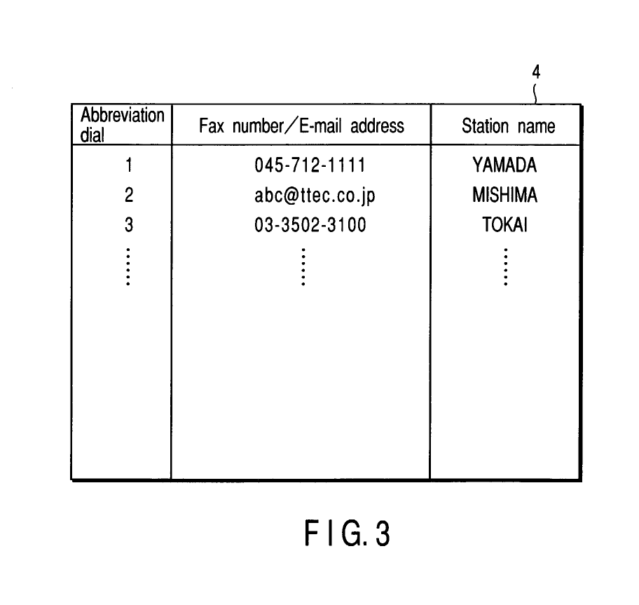

Said operation panel 8 has a key input section 9 which includes, as shown in FIG. 2, a ten-key numerical pad 9a, a facsimile key 9b as a mode setting section to set a facsimile mode, a mail key 9c as a mode setting section to set a mail mode, a search key 9d to invoke searching, an abbreviated dial number key 9e to enter an abbreviated dial number to read out a facsimile number or e-mail address stored in said registration memory 4, a plurality of one-touch dialing keys 9f to read out a facsimile number or e-mail address stored in said registration memory 4, a clear key 9g used to stop input operations or transmission halfway or to clear errors, a start key 9h to start transmission, and other keys to set the display resolution and thickness, for example. In-addition to the liquid crystal display 10 mentioned above, indicator lamps for facsimile and e-mail are also included. Said ten-key numerical pad 9a is designed to input numerals usually, but can be switched to input alphabet and Japanese katakana.

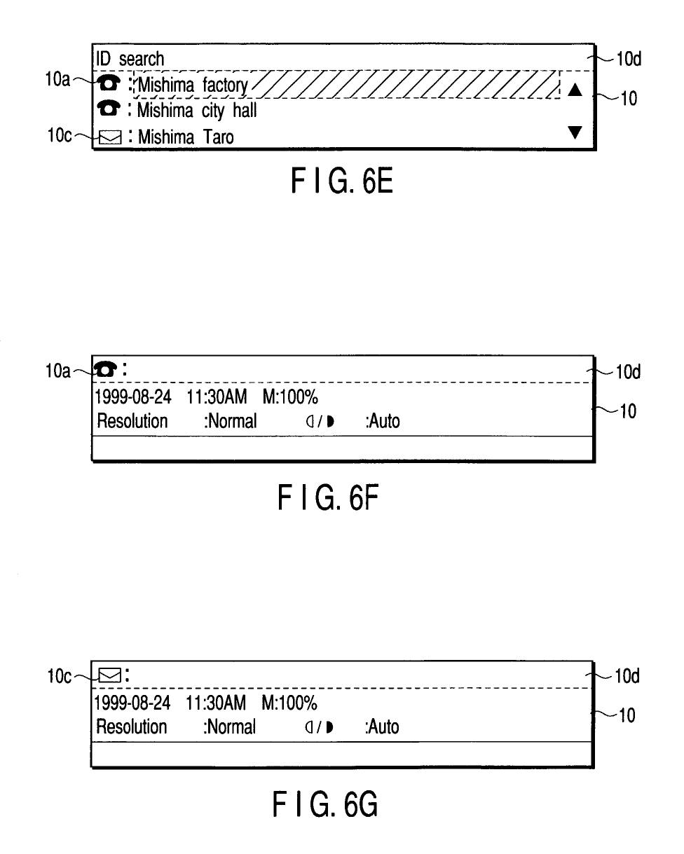

When the facsimile mode is selected, a message to urge input of a facsimile number is displayed in the upper-most area 10d of the liquid crystal display 10, as shown in FIG. 6A. When a facsimile number is input by an operator, the message disappears and the input facsimile number is displayed in the same area 10d, as shown in FIG. 6C. When the mail mode is selected, a message to urge input of an e-mail address is displayed in the upper-most area 10d of the liquid crystal display 10, as shown in FIG. 6B. When an e-mail address is input by an operator, the message disappears and the input e-mail address is displayed in the same area 10d, as shown in FIG. 6D.

Denoted at 11 is a line controller which controls telephone lines and sends and receives a signal to/from remote facsimiles. Denoted at 12 is a modem which modulates the encoded pictorial data from said encoder/decoder 7, sends it to said line controller 11 and demodulates the signal the line controller 11 receives from remote facsimiles. Denoted at 13 is a LAN controller which connects LAN and sends/receives an e-mail. These line controller 11, model 12 and LAN controller 13 constitute a communication section.

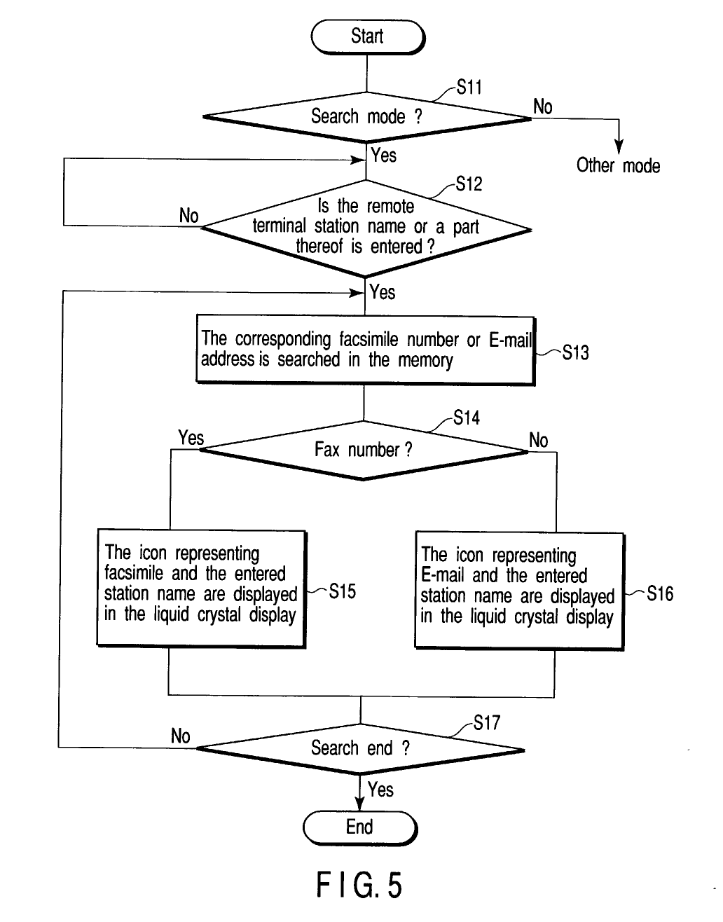

The CPU 1 controls displays as shown in FIG. 4 in the facsimile mode and mail mode. That is, when the facsimile key 9b is depressed in the key input section 9, the choice of facsimile mode is confirmed in step S1, and a message to urge input of a destination facsimile number is displayed in the first line space in the area 10d of the liquid crystal display 10 in step S2, as shown in FIG. 6A. Date and time are displayed in the second line space, display resolution and thickness are displayed in the third line space, and a function message is displayed in the fourth line space, respectively.

When a destination facsimile number is entered from the ten-key numerical pad 9a in step S3 in this state, a telephone mark icon 10a representing a facsimile appears and the input destination facsimile number 10b is displayed in the order of entry, if two or more numbers are input.

As described above, when the facsimile mode is selected and a destination facsimile number is input, the telephone mark icon 10a is displayed, and even if an operator should forget the selected mode after setting the display resolution, thickness or other conditions, the operator can certainly identify the mode (facsimile mode) by watching the telephone mark icon 10a. The message disappears in accordance with inputting the facsimile number, thereafter the icon and facsimile number are displayed in the same area. Therefore, the size of the display can be made smaller.

After all input operations are completed, when the start key 9h is depressed without touching the clear key 9g, “NO” is judged in step S4a and “YES” is judged in step S4b, the reader 5 reads the document, and the facsimile transmission is started.

If the operator notices a mis-input during the input of a destination facsimile number and operates the clear key 9g, “YES” is judged in S4a. And, all digits of the input destination facsimile number are cleared from the liquid crystal display 10, and only the icon 10a remains displayed (S5), as shown in FIG. 6F. If the operator depresses the mail key 9c in this state, “YES” is judged in S5a and the operation goes to the next step S6 where the mode is changed from facsimile to mail.

And even if the mail key 9c is depressed without touching the clear key 9g, the depressing the mail key 9c is ignored. In order to change a mode, the clear key 9g is surely depressed. Therefore, the facsimile number is prevented to remain as it is input even though the mode is changed to the mail mode. As a result, mis operation can be prevented.

As described above, when the operator notices an mis-input and depresses the clear key 9g during the input of the destination facsimile number, all the input number and symbols are immediately cleared, but the icon 10a representing the facsimile mode is not cleared, and the selected mode can be conformed even if the clearing operation is performed.

Moreover, when the mail key 9c is touched in the key input section 9, “NO” is judged in S1. Then the same transaction as in the facsimile mode is performed. And, a message to urge input of e-mail address is displayed in the first line space in the area 10d of the liquid crystal display 10 in S6, as shown in FIG. 6B.

An envelope mark icon 10c representing an e-mail appears and the input destination e-mail address is displayed in the order of input in the area 10d of the liquid crystal display 10 in step S8, as shown in FIG. 6D. (First display controller) Next, thereafter the transaction of the clear key 9g is performed in the same way as mentioned in the facsimile mode.

As described above, when the operator notices an mis-entry and depresses the clear key 9g during the input of the destination e-mail address, all the input number and symbols are immediately cleared, but the icon 10c representing the mail mode is not cleared, and the selected mode can be conformed even if the clearing operation is performed.

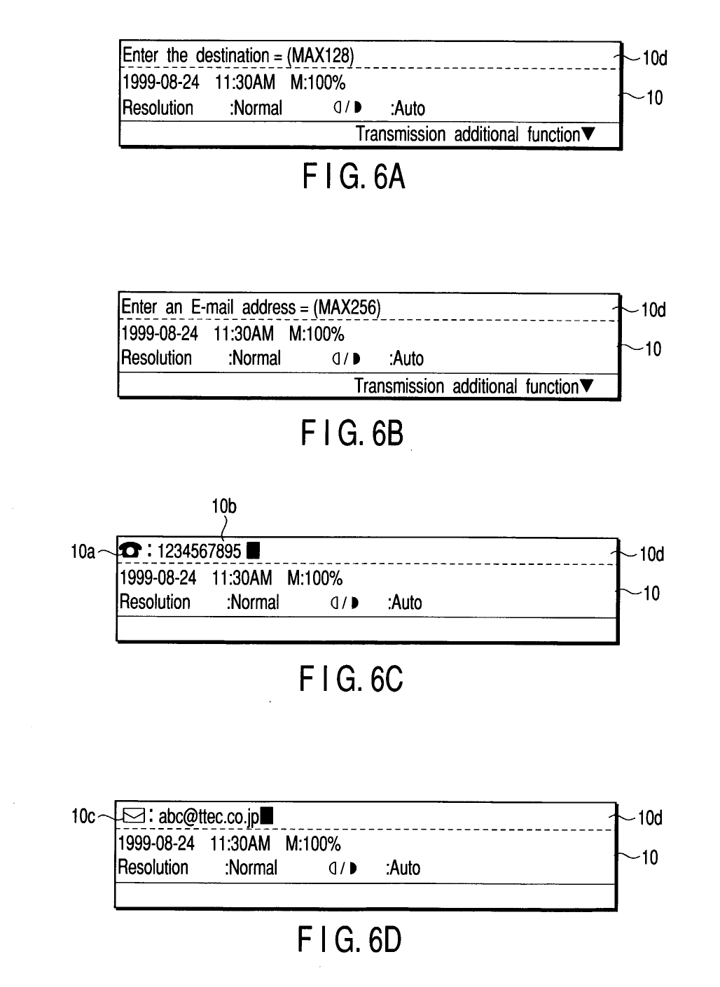

When searching the facsimile numbers or e-mail addresses of remote terminals stored in said registration memory 4, the CPU 1 proceeds the search process shown in FIG. 5.

That is, the CPU 1 judges whether the search mode is specified (S11), by detecting the depression of the search key 9d. If “YES” is judged in S11, the search mode is specified. Next, when the operator makes input from the ten-key numerical pad 9a, the CPU recognizes that the destination station name or a part thereof is entered (S12). If “YES” is judged in S12, the CPU searches the corresponding facsimile number or e-mail address in the registration memory 4 (searching section). And, the CPU confirms whether that facsimile number or e-mail address has been stored in the registration memory 4 (step S14). It judged to be an E-mail address when the entered data includes “@” or “.”, and a facsimile number when all digits are numerals.

When “YES” is judged in S14, namely, a facsimile number is found stored, the icon representing a facsimile is displayed with the corresponding station name in the liquid crystal display 10, in step S15. When the entered data is an e-mail address, the icon representing an e-mail address is displayed with the corresponding station name in the liquid crystal display 10, in step S16 (Second display controller). And, when the completion of the searching process is judged in step S17, the series of processing steps is finished.

Now, it is assumed that a part of station name “MISHIMA”, for example, is input from the ten-key numerical pad 9a. If the station named “MISHIMA” means a facsimile number, the telephone mark icon 10a and the station name will be displayed in the liquid crystal display 10, while when it means an e-mail address, the envelop mark icon 10c and the station name will be displayed, as shown in FIG. 6E. In this case, ID search is displayed in the first line space, and the icon and the station name are displayed in the following three lines. If there are four or more corresponding station names, they can be confirmed by scrolling the display screen by using the up/down key (not shown).

If the search operation is performed to confirm the station names stored in the registration memory 4, the station names whose facsimile numbers and e-mail addresses have been stored, are displayed mixed in the liquid crystal display 10. In this case, the telephone mark icon 10a appears for facsimile numbers, and the envelope mark icon 10c appears for e-mail addresses. By these icons, the operator can easily confirm which is assigned to the station name, facsimile number or e-mail address.

It is also permitted to raise a flag when a facsimile number is stored in the registration memory 4, and use this flag for the judgment, instead of the judgment in S14.

Further, the telephone mark icon 10a can be replaced by letters like “FAX NO”, as shown in FIG. 6F, or the display in the area 10d can be changed to reverse display, for example, as visual notice to urge entry of “FAX NO”.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication terminal unit having a facsimile mode of sending data to a remote terminal over a telephone line and a mail mode of sending pictorial data, as a file attached to an e-mail, to the remote terminal through a network or Internet comprising:
a display;
an input section configured to input a facsimile number or e-mail address of a destination terminal;
a mode setting section configured to set the facsimile mode and the mail mode; and
a first display controller configured to give a display identifying the facsimile mode and display the input facsimile number in said display when the facsimile number is input from the input section in the case where the facsimile mode is selected in said mode setting section, and to give the display identifying the e-mail mode and display the input e-mail address when the e-mail address is input from said input section in the case where the mail mode is selected in said mode setting section.

2. The communication terminal unit according to claim 1, wherein said first display controller displays an icon representing the facsimile in said display when a facsimile number is input from said input section, and displays an icon representing the e-mail in said display when the e-mail address is input from said input section.

3. The communication terminal unit according to claim 1, wherein said first display controller displays characters identifying the facsimile in said display when a facsimile number is input from said input section, and displays characters identifying the e-mail in said display when the e-mail address is input from said input section.

4. The communication terminal unit according to claim 1, wherein said first display controller changes the display state of the facsimile number/e-mail address input area of said display when the facsimile mode is selected in said mode setting section and when the mail mode is selected in said mode setting section.

5. The communication terminal unit according to claim 4, wherein the display state is reversed display.

6. The communication terminal unit according to claim 2, which further comprises a clear key to clear data entry, and in which said first display controller restores the display state of said display to only an icon when said clear key is depressed while the input facsimile number is being displayed with an icon representing the facsimile in the display or while the input e-mail address is being displayed with an icon representing the e-mail in said display.

7. The communication terminal unit according to claim 2, wherein said first display controller displays, in said display, a message to urge entry of a facsimile number when the facsimile mode is selected in said mode setting section, and clears the message and displays instead an icon representing a facsimile in the same area as the message displayed, and displays a facsimile number when the facsimile number is input from said input section; and displays a message to urge entry of an e-mail address in said display when the mail mode is selected in said mode setting section, and clears a message and displays instead an icon representing an e-mail in the same area as the message is displayed, and displays an e-mail address when the e-mail address is input from said input section.

8. The communication terminal unit according to claim 1, further comprising:
a registration memory configured to store facsimile numbers or e-mail addresses of remote terminals together with station names by assigning them to respective one-touch dialing keys or abbreviated dial numbers.
a communication section configured to read out facsimile numbers of the remote terminals from said memory and start facsimile when an abbreviated dial number is entered or one-touch dialing key is depressed in a facsimile mode, and read out e-mail addresses of the remote terminals from said memory and start an e-mail when an abbreviated dial number is input or one-touch dialing key is depressed in the mail mode;
a search section configured to search for a corresponding facsimile number or e-mail address in said memory when a station name or a part thereof is input; and
a second display controller which displays an icon representing a facsimile in said display and displays a corresponding station name or facsimile number when the data found by said search section is a facsimile number, and displays an icon representing an e-mail in said display and displays a corresponding station name or e-mail address when the data found by said search section is an e-mail address.

9. The communication terminal unit according to claim 8, wherein said first display controller displays an icon representing the facsimile in said display when a facsimile number is input from said input section, and displays an icon representing the e-mail in said display when the e-mail address is input from said input section.

10. The communication terminal unit according to claim 8, wherein said first display controller displays characters identifying the facsimile in said display when a facsimile number is input from said input section, and displays characters identifying the e-mail in said display when the e-mail address is input from said input section.

11. A displaying method of a communication terminal unit having communication terminal unit having a facsimile mode of sending data to a remote terminal over a telephone line and a mail mode of sending pictorial data, as a file attached to an e-mail, to the remote terminal through a network or Internet comprising:
giving a display identifying the facsimile mode and display the input facsimile number in the display when the facsimile number is input in the case where the facsimile mode is selected; and
giving the display identifying the e-mail mode and display the input e-mail address when the e-mail address is input in the case where the mail mode is selected.
